(19) United States
(12) Patent Application Publication
(10) Pub. No.: US 2008/0204451 A1
(43) Pub. Date: Aug. 28, 2008

(54) Geometry processor using a post-vertex cache and method thereof

(75) Inventors: Yeon-Ho IM, Suwon-Si (KR); Young-Jun KIM, Suwon-Si (KR)

Correspondence Address: HARNESS, DICKEY & PIERCE, P.L.C., P.O. BOX 8910, RESTON, VA, 20195, US

(73) Assignee: Samsung Electronics Co., Ltd

(21) Appl. No.: 12/071,456

(22) Filed: Feb. 21, 2008

(30) Foreign Application Priority Data
Feb. 26, 2007 (KR) 10-2007-19171

(51) Int. Cl. G06T 15/00

(52) U.S. Cl. 345/419

(57) ABSTRACT

A geometry processor of a three-dimensional graphic accelerator may include a storage unit storing vertex data and an index corresponding to the vertex data, a vertex shader geometrically processing the vertex data provided from the storage unit, a vertex cache storing vertex data geometrically processed by the vertex shader, and/or an input processing unit receiving vertex data from a central processing unit to determine whether the geometrically processed vertex data corresponding to the vertex is present in the vertex cache.

### PRIORITY STATEMENT

The present application claims priority under 35 U.S.C. § 119 on Korean Patent Application No. 10-2007-19171 filed on Feb. 26, 2007, the entire contents of which are incorporated herein by reference.

### BACKGROUND

As real-time rendering functions become available in PC-level data processing apparatuses due to the rapid development of hardware, applications of three-dimensional (3D) graphic technology may be extending to various fields of video processing. In general, a 3D computer graphic system may be regarded as an important kernel in establishing multimedia environments. To support more realistic 3D images, higher performance 3D graphic exclusive accelerators may be needed. In recent years, personal computers (PC) or gaming machines have usually employed 3D graphic accelerators.

A procedure of processing video signals in a 3D graphic accelerator may be accomplished by transferring video signals to a display unit after real-time hardware acceleration through an application program interface (API) such as Open Graphics Library (OpenGL®). OpenGL® is the name of a software solution to support a high-quality workstation-level graphic system.

The 3D graphic accelerator may have geometry processing and rendering functions. The geometry processing may be conducted for transforming a 3D object into corresponding images from various view points and projecting them on a two-dimensional (2D) coordinate system. The rendering may be conducted for determining color values of images on the 2D coordinate system and storing the determined image values in a frame buffer. After processing all input 3D data of a frame, color data stored in the frame buffer may be provided to the display unit, which may be called a “display refresh.” A geometry processor and a rendering unit may be pipelined in order to enhance performance of operation.

A geometric processing operation may be conducted in the geometry processor embedded in the 3D graphic accelerator. The geometry processor may execute a geometric process such as creating a new coordinate through multiplying vertexes, which are input from a central processing unit (CPU), by a matrix. Then, the step of rendering may proceed. Vertexes may be points of a polygon used for drawing a 3D graphic pattern. Polygons may be 2D patterns (generally, triangles and/or rectangles) forming a 3D image of object. Tens to thousands of polygons may be generally used for constituting a 3D object.

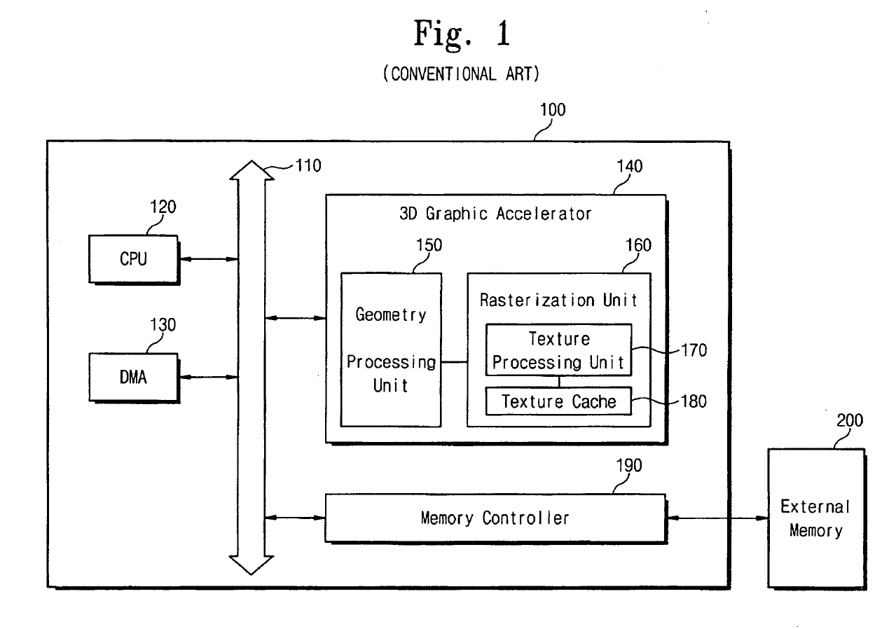

FIG. 1 is a block diagram showing a general organization of a conventional 3D graphic system. FIG. 1 shows the 3D graphic system of a system-on-chip (SOC), where a plurality of function circuits may be integrated in a single chip.

Referring to FIG. 1, the 3D graphic system 100 may be organized of a system bus 110, a plurality of bus masters connected to the system bus 110 in common, and a plurality of bus slaves. The bus masters may generate address and control signals which may be applied to the system bus 110 by timing events. The bus masters may include a CPU 120, a direct memory access (DMA) block 130, and/or a 3D graphic accelerator 140. The bus slaves may include a memory controller 190.

The CPU may control the overall operation of the 3D graphic system 100. The DMA block 130 may function to transfer data into peripheral devices, which may be associated with the 3D graphic system, without execution of a program by the CPU 120. As such, the CPU 120 may not be directly involved in the data transmission of the DMA block 130, thus improving the overall performance of data transmission in the system. The 3D graphic accelerator 140 may conduct a 3D graphic processing operation. 3D graphics may include technology for representing a 3D object in a coordinate system and realistically displaying the 3D object image on a 2D monitor. The 3D graphic accelerator 140 may be functionally divided into a geometry processing unit 150 and a rasterization unit 160.

The geometry processing unit 150 may execute geometry transformation for projecting a 3D image on the 2D coordinate system. The rasterization unit 160 may determine the latest pixel values to be output into a screen in correspondence with vertexes processed by the geometry processing unit 150. The rasterization unit 160 may conduct various kinds of filtering tasks to provide realistic 3D images. For this, the rasterization unit 160 may have a texture processing unit 170 and a texture cache.

The texture processing unit 170 may conduct a texture filtering task on the basis of polygons input from the geometry processing unit 150. Various kinds of texture data that may be used in the filtering task may be stored in an external memory 200 disposed outside of the 3D graphic accelerator 140. The texture data stored in the external memory 200 may be partly copied and stored in the texture cache 180. The external memory 200 may function as a frame buffer, a Z-buffer, an alpha buffer, a stencil buffer, and/or a texture buffer, in which the internal data storage space may be allocated to a plurality of fields.

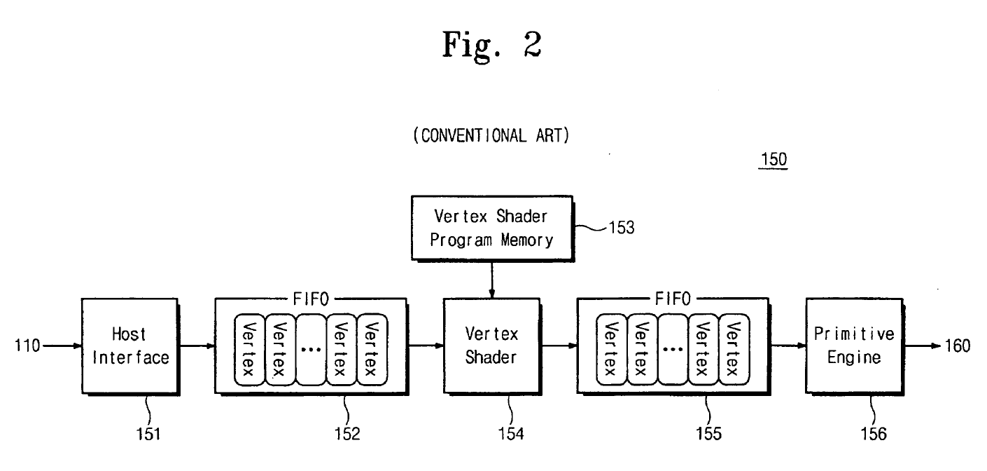

A general pipeline structure of the conventional geometry processor 150 without a vertex cache is illustrated in FIG. 2.

Referring to FIG. 2, the geometry processing unit 150 may be organized by including a host interface 151, a first-in first-out (FIFO) memory 152, a vertex-shader program memory 153, a vertex shader 154, a second FIFO memory 155, and/or a primitive engine 156.

The host interface 151 may receive vertex data from the CPU 120 by way of the system bus 110.

The first FIFO memory 152 may sequentially store the vertex data which may be transferred from the host interface 151, and may output the vertex data to the vertex shader 154 in the sequence of storage. The first FIFO memory 152 may be used for preventing functional degradation due to differences of data processing rates.

The vertex-shader program memory 153 may store matrix data for transforming a vertex coordinate. If vertex data is input into the host interface 151 from the CPU 120, the vertex shader 154 may process the vertex data by executing a vertex shader program stored in the vertex-shader program memory 153.

The vertex shader 154 may transform a coordinate of vertex data, transferred from the first FIFO memory 152, by means of the vertex shader program. The vertex shader program may perform matrix multiplication for the coordinate transformation with the matrix data that is transferred from the vertex-shader program memory 153. The second FIFO memory 155 may sequentially store vertex data that is processed by the vertex shader 154 and then may output the stored vertex data to the primitive engine 156 in the sequence of storage. The second FIFO memory 155 may be used for preventing functional degradation that occurs due to differences of data processing rates with the vertex shader 154.

The primitive engine 156 may receive the vertex data processed by the vertex shader 154, and then process the vertex data after gathering the required number of vertexes according to a polygonal pattern, such as a straight line, a triangle, or a tetragon.

In operation, the host interface 151 may transfer vertex data to the first FIFO memory 152 from the CPU 120 by way of the system bus 110. The first FIFO memory 152 may sequentially store the vertex data from the host interface 151 and output the vertex data in the sequence of storage. The vertex shader 154 may geometrically process the vertex data, which is input from the first FIFO memory 152, by means of the vertex shader program stored in the vertex-shader program memory 153, and then may transfer the geometrically processed vertex data to the second FIFO memory 155. The second FIFO memory 155 may sequentially store the vertex data processed by the vertex shader 154 and output the vertex data to the primitive engine 156 in the sequence of storage.

If an arbitrary object is formed in polygons, there may be polygons sharing the same vertexes because the vertexes are points of the polygons. For that reason, in the geometry processing unit 150, previously processed vertex data may frequently occur and be input into the graphic accelerator again for the geometric characteristics of the vertexes. Discriminating vertexes may be accomplished by indexes which are given to each of the vertexes.

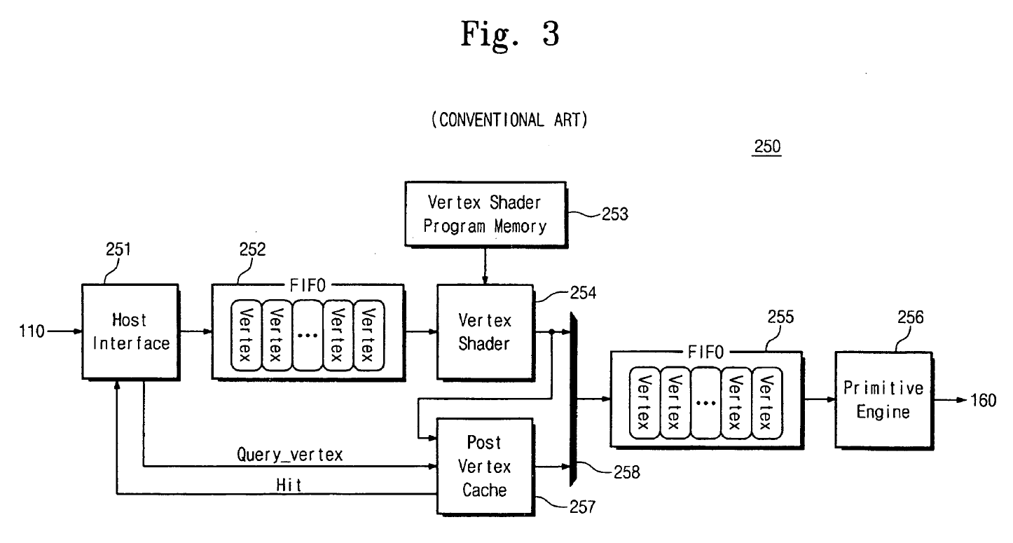

FIG. 3 is a block diagram showing a conventional geometry processing unit with a post-vertex cache. The geometry processing unit 250 shown in FIG. 3 further includes the post-vertex cache 257 and a multiplexer 258 for more rapidly processing vertexes, relative to that of FIG. 2.

Referring to FIG. 3, a second FIFO memory 255 may store vertex data processed by a vertex shader 254. The multiplexer 258 may output one of the results from the vertex shader 254 and the post-vertex cache 257.

The CPU 120 may provide a host interface 251 with a 32-bit index for discriminating vertexes through the bus 110. The host interface 251 may generate a first signal Query_vertex for finding a vertex having an index as same as that transferred to the post-vertex cache 257.

The post-vertex cache 257 may operate to determine if the vertex cache detects a cache hit or miss state, in responding to the first signal Query_vertex. The post-vertex cache 257 may activate a second signal Hit if there is cache hit and output a vertex that corresponds to the cache hit. If there is cache miss in the post-vertex cache 257, a vertex corresponding to the cache miss may be transferred to the vertex shader 254 through a first FIFO memory 252.

The host interface 251 may not transfer a vertex if the second signal Hit is inactive. In other words, the vertex shader 254 may not conduct any operation for a vertex that is a cache miss. A vertex stored in a second FIFO memory 255 may be transferred into a primitive engine 256.

The second FIFO memory 255 may store 16 results in processing a vertex. One vertex may have 16 attributes. For instance, the vertex data may contain information about an X-coordinate, a Y-coordinate, a Z-coordinate, RGB, texture, and so forth.

Assuming that the 16 vertex attributes are represented in four double words (DWORD=32 bits), a required size of memory may be 4 kilobytes (KB). That is, (16-vertex*16-attribute/vertex*4-DWORD*4-byte/DWORD)=4 kilobytes.

The post-vertex cache 257 may be used to additionally employ a 4 KB-memory. This may be regarded as a considerable memory size in a mobile environment.

Further, considering that the second FIFO memory 255 for transferring the processed vertex data between the vertex shader 254 and the primitive engine 256 may be able to store 16 vertex-processing results, a memory size for the second FIFO memory 255 may become 4 KB by the same calculation manner as aforementioned.

By reducing a memory space used for the vertex processing, chip size may be scaled down. Modifying the architecture so as to extend a texture cache size for improvement of systemic performance may be profitable for mobile environments.

### SUMMARY

Example embodiments may be directed to an apparatus enhancing a processing rate of a geometry processing unit in a smaller chip size.

According to example embodiments, a geometry processor of a three-dimensional graphic accelerator may include a storage unit storing vertex data and an index corresponding to the vertex data, a vertex shader geometrically processing the vertex data provided from the storage unit, and/or a vertex cache storing vertex data geometrically processed by the vertex shader. The geometry processor may further include an input processing unit receiving vertex data from a central processing unit and determining whether the geometrically processed vertex data corresponding to the vertex is present in the vertex cache.

According to example embodiments, a geometry processing method of a three-dimensional graphic accelerator may include inputting vertex data, the vertex data including an index corresponding to the vertex data, finding whether geometrically processed vertex data corresponding to the vertex is present in a vertex cache, the vertex cache including a FIFO memory, and/or outputting the geometrically processed vertex data if the geometrically processed vertex data corresponding to the vertex is present in the vertex cache.

A further understanding of the nature and advantages of example embodiments herein may be realized by reference to the remaining portions of the specification and the attached drawings.

### BRIEF DESCRIPTION

Non-limiting and non-exhaustive example embodiments will be described with reference to the following figures, wherein like reference numerals refer to like parts throughout the various figures unless otherwise specified. In the figures:

FIG. 1 is a block diagram showing a general organization of a conventional 3D graphic system;

FIG. 2 is a block diagram showing a conventional geometry processing unit without a vertex cache;

FIG. 3 is a block diagram showing a conventional geometry processing unit with a post-vertex cache;

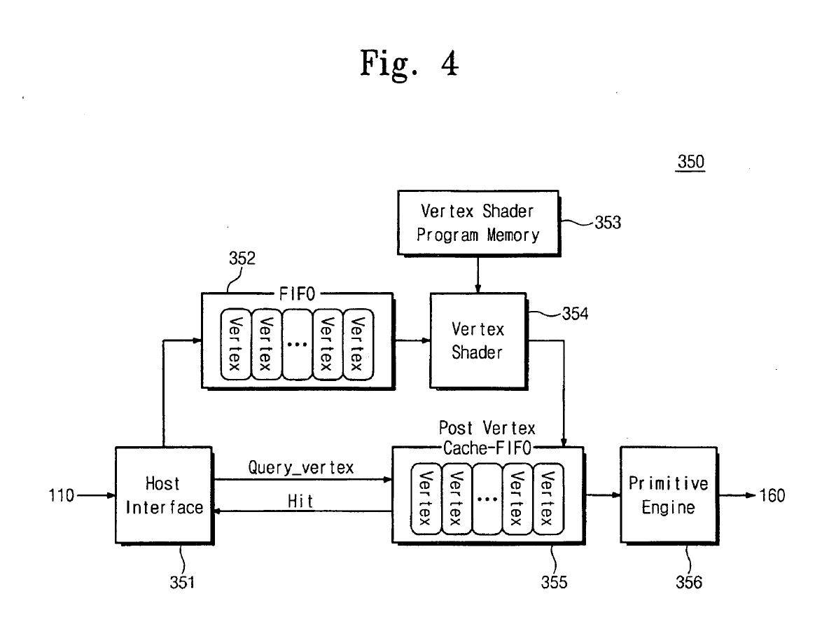

FIG. 4 is a block diagram of a geometry processor according to example embodiments;

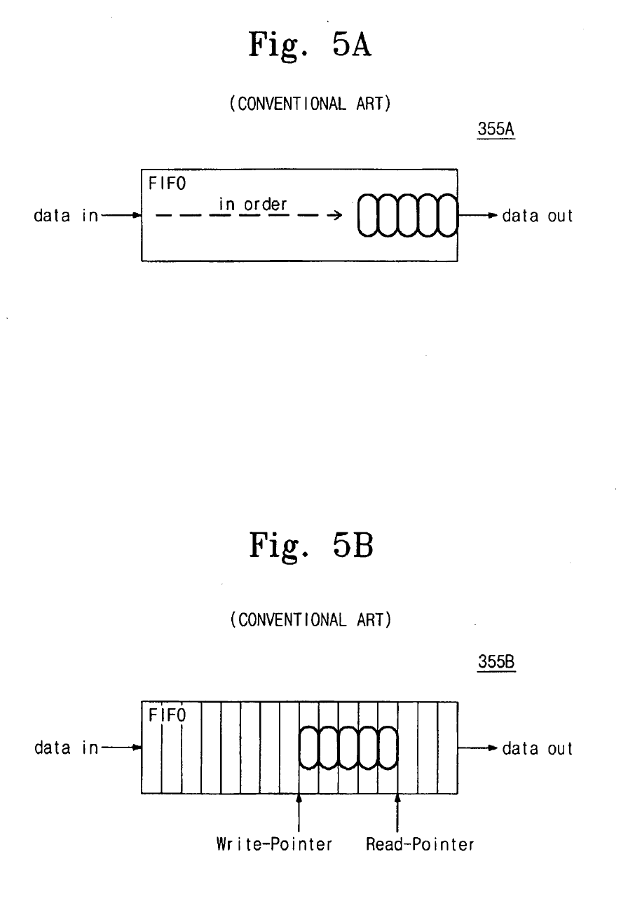

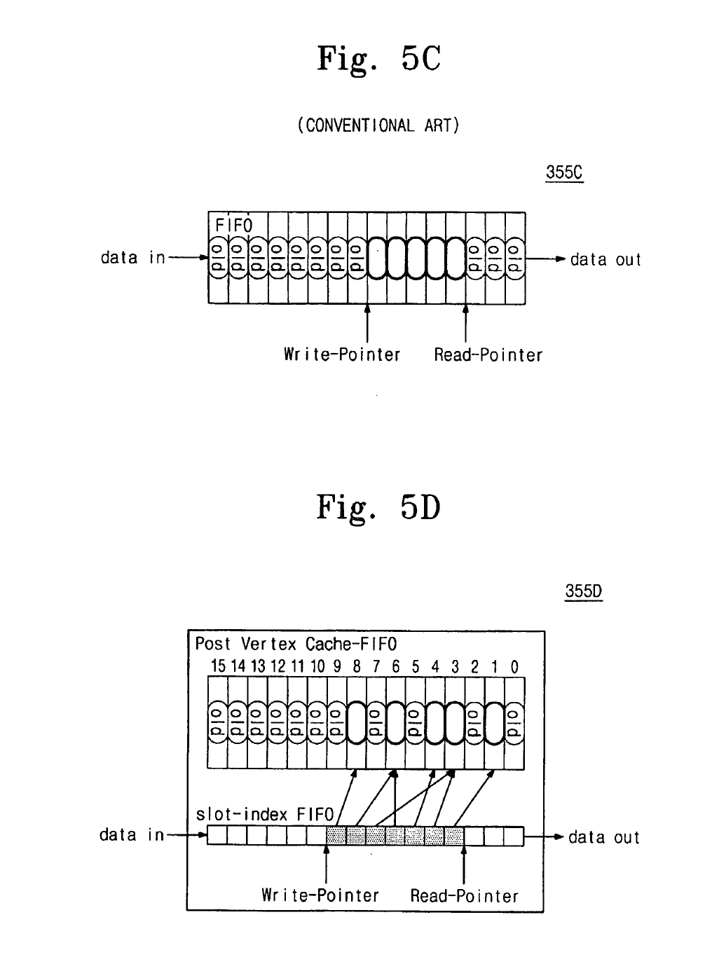

FIGS. 5A through 5D illustrate structural configurations and methods for using a FIFO memory as a post-vertex cache FIFO memory;

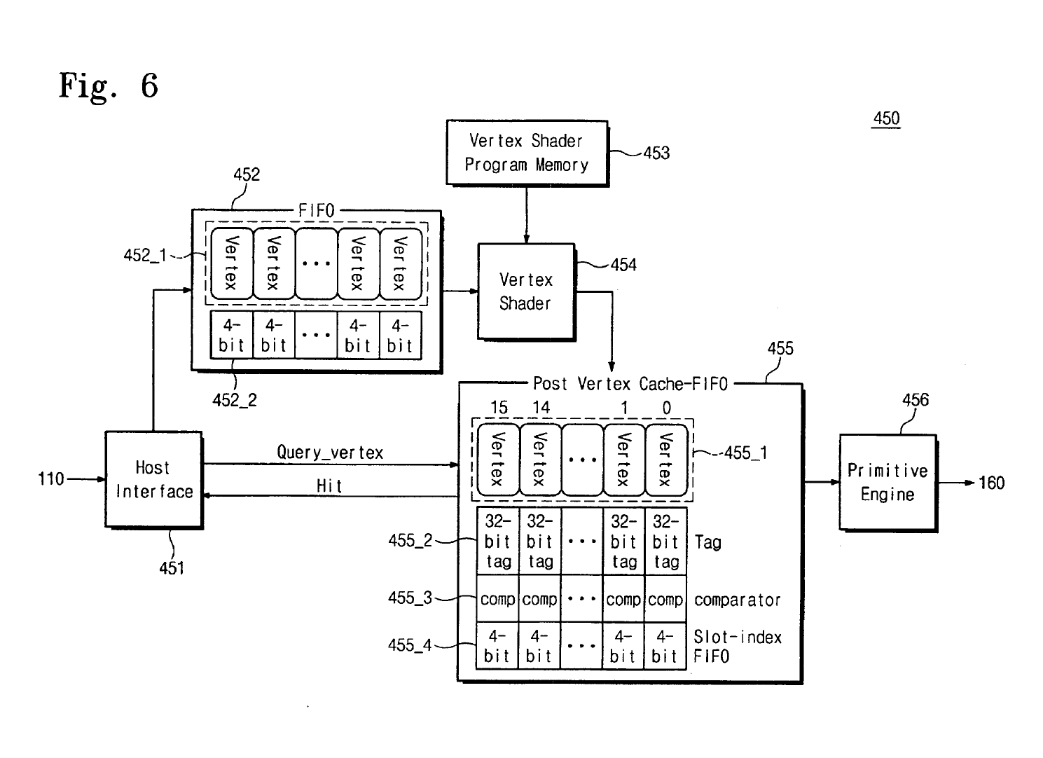

FIG. 6 is another block diagram of a geometry processor according to example embodiments; and

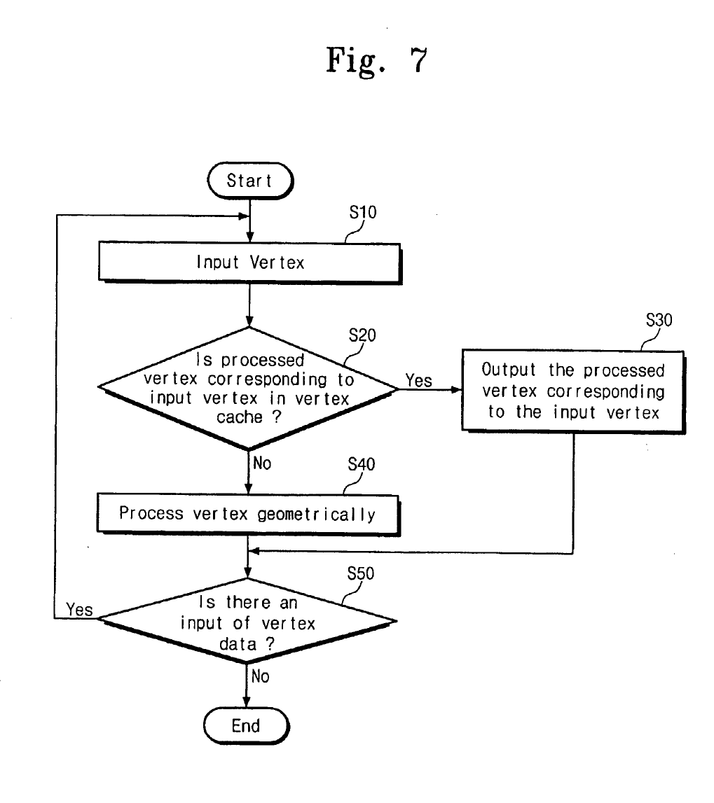

FIG. 7 is a flow chart of a scan test method according to example embodiments.

### DETAILED DESCRIPTION

Example embodiments will be described below in more detail with reference to the accompanying drawings. Example embodiments may, however, be embodied in different forms and should not be constructed as limited to the embodiments set forth herein. Rather, these embodiments are provided so that this disclosure will be thorough and complete, and will fully convey the scope of example embodiments to those skilled in the art. Like reference numerals refer to like elements throughout the accompanying figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

FIG. 4 is a block diagram of a geometry processor according to example embodiments. FIGS. 5A through 5D illustrate structural configurations and methods for using a FIFO memory as a post vertex-cache.

Referring to FIG. 4, the geometry processor 350 according to example embodiments includes a post-vertex cache-FIFO memory 355.

The post-vertex cache-FIFO memory 355 may function as a cache, and store vertex data. The cache and FIFO functions of the post-vertex cache-FIFO memory 355 will be described in conjunction with FIGS. 5A through 5D.

FIG. 5A is a block diagram of a general FIFO memory; FIG. 5B is a block diagram of a FIFO memory associated with a read-pointer and a write-pointer; FIG. 5C is a block diagram illustrating an operation of the FIFO memory shown in FIG. 5B; and FIG. 5D is a block diagram of an organization in which a slot index is added to the FIFO memory in order to implement the post-vertex cache-FIFO memory shown in FIG. 5C. FIG. 5C illustrates a practical status in the inside of the FIFO memory, which shows that data may remain in the FIFO memory even though used data has been output therefrom previously.

The configurations shown by FIGS. 5A through 5C are to illustrate the capability of conducting a cache operation by the FIFO memory. The FIFO memory 355A may be a conventional FIFO memory that temporarily stores vertex data output from a vertex shader 354 and outputs the vertex data in the input sequence. Thus, the FIFO memory 355A may function to compensate a gap of processing rates when the vertex shader 354 operates rapidly or slowly for a while, enabling the vertex shader 354 to uniformly operate for fetching vertex data.

The FIFO memory 355B is organized by including the read-pointer and the write-pointer in a conventional FIFO memory as shown in FIG. 5A.

The FIFO memory 355C is configured to reuse data when the data stored is the same as the data input thereto, as shown in FIG. 5C. In other words, the FIFO memory 355C may be able to conduct a cache function by storing a result of the vertex shader 354.

The FIFO memory 355D is equipped with a slot index FIFO unit to store a 4-bit slot index for a vertex cache function, as shown in FIG. 5D. The slot index may indicate addresses of empty storage spaces of the FIFO memory 355D. Thus, when the slot index is output from the slot index FIFO unit, the FIFO memory 355D may output the memory contents, which may be designated by the slot index.

FIG. 6 is another block diagram of a geometry processor according to example embodiments. The geometry processor shown in FIG. 6 is similar to that shown in FIG. 4, except for the post-vertex cache-FIFO memory 455.

Referring to FIG. 6, the geometry processor 450 includes a host interface (or input processing unit) 451, a FIFO memory 452, a vertex-shader program memory 453, a vertex shader 454, a post-vertex cache-FIFO memory 455, and a primitive engine 456.

The host interface 451 may receive vertex data transferred from the CPU 120 by way of the bus 110. The FIFO memory 452 may sequentially store the vertex data, which may be transferred from the host interface 451, and may store an index corresponding to the vertexes, and may sequentially output the vertex data and index to the vertex shader 454. The vertex-shader program memory 453 may store a vertex shader program for an operation of the vertex shader 454. If there is an input of vertex data from the host interface 451, the vertex shader 454 may process the input vertex data by executing the vertex shader program.

The post-vertex cache-FIFO memory 455 may include a memory unit 455_1 storing vertex data processed by the vertex shader 454, a tag unit 455_2, a comparing unit 455_3, and a slot index unit 455_4.

The memory unit 455_1 may store output vertex data of the vertex shader 454. The tag unit 455_2 may store an index of vertexes. The comparing unit 455_3 may determine a cache hit or miss from comparing the vertex index, which is stored in the tag unit 455_2, with an index requested by the host interface 451. The slot index unit 455_4 may store locations of the memory unit 455_1.

When there is cache hit, the slot index unit 455_4 may store a slot index indicating where the cache hit occurs, in order to utilize a result stored in the post-vertex cache-FIFO memory 455 without transferring the corresponding vertex data into the FIFO memory 452. When there is cache miss, a disused slot of the memory unit 455_1 may be allocated and a number of the allocated slot may be stored in the slot index unit 455_4. That same number of the allocated slot may also be stored in a slot FIFO memory 452_2. The vertex shader 454 may process the vertex data stored in the FIFO memory 452 and then write a processed result into the memory unit 455_1 of the post-vertex cache-FIFO memory 455. Locations of the memory unit 455_2 may be set by using slot numbers stored in the slot FIFO memory 452_2.

The CPU 120 may provide the host interface 451 with a 32-bit index, by way of the bus 110, for discriminating vertexes. When the host interface 451 is operating as a bus master, the 32-bit index may be read out directly from the memory through the host interface 451.

The first signal Query_vertex may contain a vertex index. The host interface 451 may transfer the first signal Query_vertex for finding whether there is a vertex having the same index already transferred to the post-vertex cache-FIFO memory 455.

The second signal Hit may contain a slot index and a result representing a cache hit or miss in response to the first signal Query_vertex. The slot index may denote locations of the memory unit 455_1 in the post-vertex cache-FIFO memory 455, which stores a result of processed vertex data, which is significant only in the state of a cache miss.

In the post-vertex cache-FIFO memory 455, the first signal Query_vertex may be compared with the vertex index of the tag unit 455_2 by the comparing unit 455_3.

If a vertex index included in the first signal Query_vertex is already stored in the post-vertex cache-FIFO memory 455, the post-vertex cache-FIFO memory 455 may activate the second signal Hit. In other words, if there is cache hit in the post-vertex cache-FIFO memory 455, a 4-bit slot index of the position where the cache hit occurs may be input into the slot index unit 455_4 of the post-vertex cache-FIFO memory 455.

The host interface 451 may not transfer vertex data in accordance with activation of the second signal Hit. Namely, the vertex shader 454 may simply transfer vertex data to the primitive engine 456 through the post-vertex cache-FIFO memory 455, without any operation.

If a vertex index included in the first signal Query_vertex is not stored in the post-vertex cache-FIFO memory 455, the post-vertex cache-FIFO memory 455 may inactivate the second signal Hit. In other words, if there is cache miss in the post-vertex cache-FIFO memory 455, the post-vertex cache-FIFO memory 455 may allocate an empty slot of the slot index unit 455_4 and then transfer the slot number to the host interface 451. The host interface 451 may store the slot number into the slot FIFO memory 452_2. The post-vertex cache-FIFO memory 455 may store a 4-bit slot index of the vertex, at which the cache miss occurs, in an empty slot of the slot index unit 455_4.

As a requested vertex data is absent in the post-vertex cache-FIFO memory 455, the host interface 451 may read vertex data of the corresponding index from the memory 200 through the bus 110 and then output the vertex data to the FIFO memory 452. The vertex shader 454 may process the vertex data input from the FIFO memory 452 and thereafter store a vertex processing result in a corresponding location of the memory unit 455_1 by means of a slot number read from the slot FIFO memory 452_2.

FIG. 7 is a flow chart showing an operation of the post-vertex cache-FIFO memory according to example embodiments. Referring to FIG. 7, vertex data may be input at S10. At S20, it may be determined whether there is a processed vertex in the post-vertex cache-FIFO memory corresponding to the vertex data input at S10. If there is a processed vertex corresponding to the input vertex data, data of the processed vertex may be output at step S30. If not, the input vertex data may be geometrically processed at S40. At S50, it may find whether there is an input of vertex data. If there is no input of vertex data, the procedure may be terminated. If there is an input of vertex data, the next step may be to return to S10.

Example embodiments may be useful to improving the performance of a system by adding the cache function to the FIFO memory between the vertex shader and the primitive engine.

As described above, example embodiments are advantageous to enhancing performance of the geometry processor, by means of the vertex cache function added to the FIFO memory, if previously processed vertex data is repeatedly input thereto.

The above-disclosed subject matter is to be considered illustrative, and not restrictive, and the appended claims are intended to cover all such modifications, enhancements, and other embodiments, which fall within the true spirit and scope of example embodiments. Thus, to the maximum extent allowed by law, the scope of example embodiments is to be determined by the broadest permissible interpretation of the following claims and their equivalents, and shall not be restricted or limited by the foregoing detailed description.

What is claimed is:

1. A geometry processor of a three-dimensional graphic accelerator, comprising:
a storage unit that stores vertex data and an index corresponding to the vertex data;
a vertex shader that geometrically processes the vertex data provided from the storage unit; and
a vertex cache that stores vertex data geometrically processed by the vertex shader, the vertex cache including a FIFO memory.

2. The geometry processor of claim 1, wherein the storage unit includes a FIFO memory.

3. The geometry processor of claim 1, wherein the vertex cache includes:
a memory unit that stores the geometrically processed vertex data from the vertex shader;
a tag unit that stores an index that corresponds to the vertex;
a comparing unit that determines cache hit and miss states of the vertex cache by comparing a vertex index of the vertex cache with a vertex index requested by an input processing unit; and
a slot index unit that stores information of a location where the processed vertex data is stored.

4. The geometry processor of claim 3, wherein the memory unit and the storage unit each include a FIFO memory.

5. The geometry processor of claim 3, wherein the vertex cache allocates an empty slot of the slot index unit and transfers an index of the allocated slot to the input processing unit during a cache miss state.

6. The geometry processor of claim 3, wherein the input processing unit writes the slot index, which is transferred from the vertex cache, into an index slot of the storage unit if there is the cache miss.

7. The geometry processor of claim 3, wherein the vertex cache transfers the geometrically processed vertex data to a primitive engine if there is the cache hit.

8. The geometry processor of claim 1, further comprising:
an input processing unit that receives vertex data from a central processing unit and determines whether the geometrically processed vertex data corresponding to the vertex is present in the vertex cache.

9. The geometry processor of claim 8, wherein the input processing unit holds the vertex data if the geometrically processed vertex data is present in the vertex cache and transfers the vertex data to the storage unit if the geometrically processed vertex data is absent in the vertex cache.

10. The geometry processor of claim 1, further comprising:
a vertex-shader program memory that stores matrix data for transforming a vertex coordinate, with the vertex shader processing the vertex data by executing a vertex shader program stored in the vertex-shader program memory; and
a primitive engine that processes the vertex data after gathering the required number of vertexes according to a polygonal pattern.

11. A geometry processing method of a three-dimensional graphic accelerator, comprising:
inputting vertex data;
finding whether geometrically processed vertex data corresponding to the vertex is present in a vertex cache, the vertex cache including a FIFO memory; and
outputting the geometrically processed vertex data if the geometrically processed vertex data corresponding to the vertex is present in the vertex cache.

12. The method of claim 11, wherein the inputting includes holding the vertex data if the geometrically processed vertex data is present in the vertex cache and transferring the vertex data if the geometrically processed vertex data is absent in the vertex cache.

13. The method of claim 11, further comprising:
geometrically processing the vertex data if the corresponding geometrically processed vertex data is absent in the vertex cache.

14. The method of claim 13, wherein the geometrically processing includes:
storing matrix data for transforming a vertex coordinate; and
processing the vertex data by executing a vertex shader program using the stored matrix data.

15. The method of claim 11, wherein the outputting includes:
finding whether there is the input vertex data; and
terminating if the input vertex data is absent and conducting the inputting if the input vertex data is present.

16. The method of claim 15, wherein the outputting further includes processing the vertex data after gathering the required number of vertexes according to a polygonal pattern.

17. The method of claim 11, wherein the vertex cache includes:
storing the geometrically processed vertex data from the vertex shader;
storing an index that corresponds to the vertex;
comparing a vertex index of the vertex cache with a vertex index requested by an input processing unit to determine cache hit and miss states of the vertex cache; and
storing information of a location where the processed vertex data is stored.

18. The method of claim 17, wherein the vertex cache allocates an empty slot and transfers an index of the allocated slot during the cache miss state.

19. The method of claim 18, wherein the index of the allocated slot is transferred from the vertex cache and stored if there is the cache miss.

20. The method of claim 17, wherein the outputting includes the vertex cache transferring the geometrically processed vertex data if there is the cache hit.
